(19) United States
(12) Patent Application Publication
(10) Pub. No.: US 2017/0220170 A1
(43) Pub. Date: Aug. 3, 2017

(54) Three-Dimensional Touch Recognition Apparatus and Method

(71) Applicant: Hyundai Motor Company, Seoul (KR)

(72) Inventors: Sung Jin Sah, Suwon-si (KR); Kwang Myung Oh, Suwon-si (KR); Sung Min Park, Seoul (KR)

(21) Appl. No.: 15/413,548

(22) Filed: Jan. 24, 2017

(30) Foreign Application Priority Data
Jan. 29, 2016 (KR) 10-2016-0011590

(51) Int. Cl. G06F 3/041

(52) U.S. Cl. CPC G06F 3/0414; G06F 3/0418; G06F 2203/04104

(57) ABSTRACT

The present disclosure relates to a three-dimensional touch recognition apparatus and a three-dimensional touch recognition method. The three-dimensional touch recognition apparatus may include a first sensor unit configured to detect a touch, a second sensor unit vertically spaced apart from the first sensor unit and configured to measure a touch force applied from the outside when the touch is detected at a plurality of measurement sites. The apparatus may also include a control device configured to calculate a distance between a first touch location measured by the first sensor unit and a second touch location measured by the second sensor unit and to verify whether the calculated distance between the first touch location and the second touch location exceeds a threshold value to recognize a touch input.

### CROSS-REFERENCE TO RELATED APPLICATIONS

This application is based on and claims the benefit of priority to Korean Patent Application No. 10-2016-0011590, filed on Jan. 29, 2016, in the Korean Intellectual Property Office, the disclosure of which is incorporated herein in its entirety by reference.

### TECHNICAL FIELD

The present disclosure relates to a three-dimensional touch recognition apparatus and a three-dimensional touch recognition method in which a three-dimensional touch input may be recognized by using a force sensor.

### BACKGROUND

A touch panel is a user interface, through a user manipulation may be simply and intuitively input by touching a surface of a display or a specific contact surface with a finger or an electronic pen. The touch panel is being applied to various fields such as a navigation device, a telematics terminal, a personal digital assistant (PDA), a laptop computer, a notebook computer, and a smartphone.

The touch panel uses touch recognition technologies, such as a resistive overlay type, a capacitive overlay type, a surface acoustic wave type, and an infrared beam type. An existing touch recognition technology is limited to a 2D touch interaction because touch coordinates, that is, an X axis coordinate and an Y axis coordinate, on a plane is recognized.

In order to overcome the limit of the 2D touch interaction, a force based touch recognition technology (three-dimensional touch interaction) of recognizing a touch force together with touch coordinates by using a force sensor has been suggested. The expansion of the interaction using the force based touch recognition technology is based on the magnitude of a vertical load applied in a vertical direction and the magnitude of a shear force generated by a horizontal frictional force between a finger and a touch contact surface.

When the shear force is utilized, it is very important to distinguish two different inputs in the force based touch recognition technology due to the similarity of the movements of the touch coordinates due to the gestures and inputs of the sliding and shear force input methods. In an existing method for distinguishing the inputs, a touch coordinate movement due to sliding and a touch coordinate movement due to a shear force are distinguished with reference to simple coordinate movement times, so there is a high possibility of generating a recognition error for the touch input.

### SUMMARY

An aspect of the present disclosure provides a three-dimensional touch recognition apparatus and a three-dimensional touch recognition method by which a shear force event generated by a spacing structure between a touch sensor and a force sensor may be accurately recognized.

According to an aspect of the present disclosure, a three-dimensional touch recognition apparatus may include a first sensor unit configured to detect a touch, a second sensor unit vertically spaced apart from the first sensor unit and configured to measure a touch force applied from the outside when the touch is detected at a plurality of measurement sites. A control device is configured to calculate a distance between a first touch location measured by the first sensor unit and a second touch location measured by the second sensor unit and to verify whether the calculated distance between the first touch location and the second touch location exceeds a threshold value to recognize a touch input.

The first sensor unit may be implemented by any one of a touch pad, a touch film, and a touch sheet.

The first sensor unit may use any one touch recognition technology of a resistive overlay type, a capacitive overlay type, a surface acoustic wave type, and an infrared beam type.

The second sensor unit may include a plurality of force sensors arranged on one side of the first sensor unit at different sites.

The control device may include a first sensor control unit configured to calculate the first touch location based on a signal output from the first sensor unit, a second sensor control unit configured to, if a plurality of force data are input from the second sensor unit, calculate the second touch location by using a force based touch location recognition algorithm, and a processing unit configured to calculate a distance between the first touch location and the second touch location, to verify whether the calculated distance exceeds the threshold value, and to classify the touch input based on the verification result to recognize the touch input.

The processing unit may calculate a magnitude of a vertical load at the second touch location by using the plurality of force data, and may set the threshold based on the calculated magnitude of the vertical load.

The processing unit may consider a sensor error when the threshold value is set.

The touch input may be classified into a shear force event and a sliding event.

According to another aspect of the present disclosure, a three-dimensional touch recognition method may include detecting a touch and a touch force through a first sensor unit and a second sensor unit that are vertically spaced apart from each other, calculating a first touch location measured by the first sensor unit and a second touch location measured by the second sensor unit, calculating a distance between the first touch location and the second touch location, verifying whether the distance between the first touch location and the second touch location exceeds a threshold value, and recognizing a touch input based on whether the distance between the first touch location and the second touch location exceeds the threshold.

The first sensor unit may include a sensor that uses any one touch recognition technology of a resistive overlay type, a capacitive overlay type, a surface acoustic wave type, and an infrared beam type.

The second sensor unit may include a plurality of force sensors arranged on one side of the first sensor unit at different sites.

The first touch location may be calculated based on a signal output from the first sensor unit.

The second touch location may be calculated by applying a force based touch location recognition algorithm if a plurality of force data measured at a plurality of measurement sites by the second sensor unit are input.

The three-dimensional touch recognition method may further include, after detecting the touch and the touch force, calculating a magnitude of a vertical load by using a plurality of force data that are output from the second sensor unit, and setting the threshold value based on the magnitude of the vertical load.

The recognizing of the touch input may include if a distance between the first touch location and the second touch location exceeds the threshold value, recognizing that a shear force event is generated.

The recognizing of the touch input may include, if a distance between the first touch location and the second touch location is the threshold value or less, recognizing that a sliding event is generated.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a 3-D touch recognition apparatus according to an embodiment of the present disclosure;

FIG. 2 is a structural view of the touch input device of FIG. 1;

FIGS. 3 to 7 are views for explaining a method of calculating a second touch location according to the present disclosure;

FIG. 8 is a view for explaining setting of a threshold value related to the present disclosure;

FIG. 9 is a flowchart illustrating a 3-D touch recognition method according to an embodiment of the present disclosure;

FIG. 10, which includes views labeled (a), (b) and (c), is a view illustrating an example of performing enlargement and reduction through a shear force event according to the present disclosure;

FIG. 11, which includes views labeled (a) and (b), is a view illustrating an example of performing rotation through a shear force touch according to the present disclosure; and

FIG. 12 is a view illustrating an example of selecting a menu through a shear force touch according to the present disclosure.

### DETAILED DESCRIPTION OF ILLUSTRATIVE EMBODIMENTS

The terms, such as “comprising”, “including”, and “having”, which are described in the specification mean that a corresponding element may be provided as long as there is no particularly contradictory description, and may mean that another element is not excluded but may be further included.

Further, the terms, such as “unit”, “-er, -or”, and “module” described in the specification mean a unit for processing at least one function or operation, and may be implemented by hardware, software, or a combination of hardware and software. Further, the articles, such as “a (an)” and “the”, may be used to include both a singular form and a plural form as long as another meaning is indicated or the meaning is not clearly contradicted by the context describing the present disclosure unlike the specification.

Hereinafter, exemplary embodiments of the present disclosure will be described in detail with reference to the accompanying drawings.

The present disclosure relates to a three-dimensional touch recognition technology for classifying and recognizing a shear force in a touch input device including a force sensor.

In the specification, a shear force is a force that is horizontally applied on a touch surface, and is also called a frictional force. A shear force in a touch input device is classified into a static shear force and a kinetic shear force. The present disclosure provides a three-dimensional touch recognition technology of classifying a touch input in a touch input device into a dislocation by a static frictional force and a slide by a kinetic frictional force to recognize them.

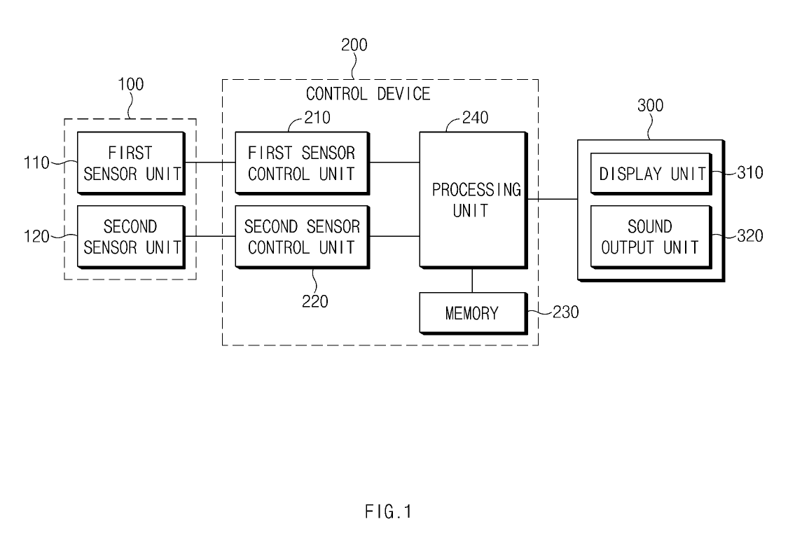

FIG. 1 is a block diagram illustrating a 3-D touch recognition apparatus according to an embodiment of the present disclosure.

As illustrated in FIG. 1, the three-dimensional touch recognition apparatus includes a touch input device 100, a control device 200, and an output device 300.

The touch input device 100 includes a first sensor unit 110 that detects a touch and a second sensor unit 120 that measures a touch force. Here, a touch force refers to an external force that is applied by a pressure of a touch.

The sensor unit 110 detects a touch made by an object such as a finger or a stylus. The first sensor unit 110 may be implemented in a form of, for example, a touch panel, a touch pad, a touch film, or a touch sheet.

The first sensor unit 110 uses any one touch recognition technology of a resistive overlay type, a capacitive overlay type, a surface acoustic wave type, and an infrared beam type.

The second sensor unit 120 is installed to be vertically spaced apart from one side surface of the first sensor unit 110 by a specific gap. The second sensor unit 120 measures a touch force that is applied from the outside when a touch is detected through the first sensor unit 110 at a plurality of different measurement sites.

The second sensor unit 120 includes a force sensor, such as a strain gauge, which measures a strain by a touch force. That is, the second sensor unit 120 measures force data at various measurement sites through a plurality of force sensors installed in the measurement sites.

The control device 200 recognizes a touch input that is input through the touch input device 100 to control an operation of an application corresponding to the touch input, and includes a first sensor control unit 210, a second sensor control unit 220, a memory 230, and a processing unit 240.

When a touch input is made, the first sensor control unit 210 calculates a first touch location based on a signal that is output from the first sensor unit 110. For example, if a touch input is detected, the first sensor control unit 210 calculates a center coordinate of a contact area, which the finger contacts, on a touch surface of the first sensor unit 110.

If a plurality of force data, which are output from the second sensor unit 120, are input, the second sensor control unit 220 calculates a second touch location by using a force based touch location recognition algorithm. Here, the second touch location is obtained by calculating a center coordinate (a center coordinate of a force) of a contact area by a touch force.

The memory 230 stores a force based touch location recognition algorithm, a threshold value, a lookup table, setting data, and input/output data.

The memory 230 may be implemented by one or more of storage media such as a flash memory, a hard disk, a secure digital (SD) card, a random access memory (RAM), a read only memory (ROM), and web storage

The processing unit 240 calculates a magnitude of a vertical load by using a plurality of force data that are measured through the second sensor control unit 220. The processing unit 240 sets a threshold value in consideration of a magnitude of a vertical load and a sensor error.

The processing unit 240 calculates a distance between the first touch location and the second touch location that are output from the first sensor control unit 210 and the second sensor control unit 220. The processing unit 240 verifies whether the calculated distance between the first touch location and the second touch location exceeds a threshold value to classify the touch input. Here, the touch input includes a shear force event and a sliding event.

If the calculated distance between the first touch location and the second touch location exceeds the threshold value, the processing unit 240 recognizes that a shear force event is generated. Meanwhile, if the calculated distance between the first touch location and the second touch location is the threshold value or less, the processing unit 240 recognizes that a sliding event is generated.

The output device 300 generates one or more of visual information, audible information, and haptic information, and includes a display unit 310 and a sound output unit 320.

The display unit 310 displays a process and a result due to an operation of the three-dimensional touch recognition apparatus.

The display unit 310 may include any one of a liquid crystal display (LCD), a thin film transistor-liquid crystal display (TFT-LCD), an organic light-emitting diode (OLED), a flexible display, a 3D display, a transparent display, and a head-up display (HUD)

The display unit 310 may be implemented by a touch screen that defines a mutual layer structure with the first sensor unit 110. In this case, the display unit 310 may be used also as an input device, in addition to an output device.

The sound output unit 320 outputs audio data that is stored in the memory 230. The sound output unit 320 outputs a sound signal related to a function performed by the three-dimensional touch recognition apparatus. The sound output unit 320 may include a receiver, a speaker, and a buzzer.

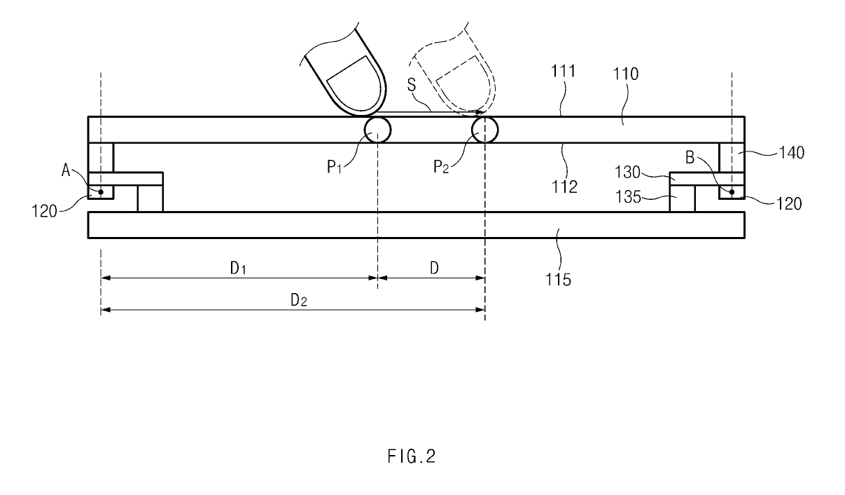

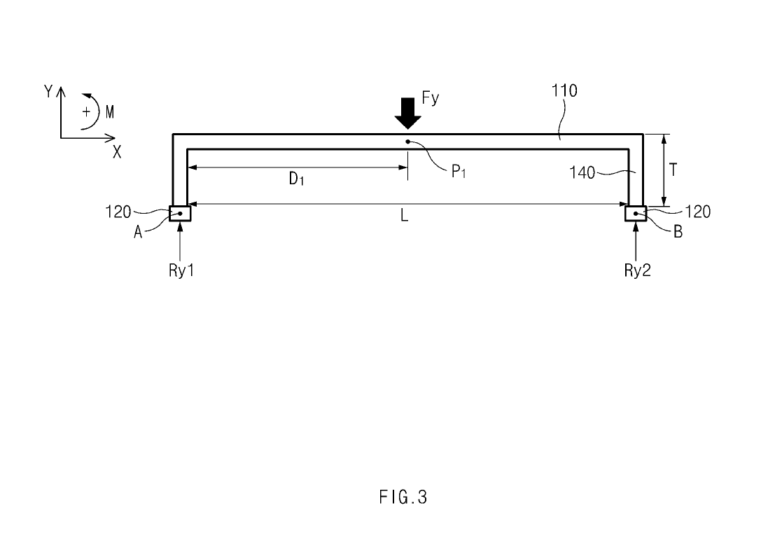

FIG. 2 illustrates a structural diagram of the touch input device 100 of FIG. 1. FIGS. 3 to 7 are views for explaining a method of calculating a second touch location according to the present disclosure.

Referring to FIG. 2, the touch input device 100 includes a first sensor unit 110, a second sensor unit 120, a resilient body 130, a support 135, and a connection member 140.

The first sensor unit 110 may be implemented in a planar pad form as illustrated in FIG. 2. Although it is described as an example in the embodiment that the first sensor unit 110 is implemented in a planar pad form, the present disclosure is not limited thereto and may be implemented in a plate form having a curvature.

A first surface 111 of the first sensor unit 110 is a touch surface to which a touch is input. The first sensor unit 110 detects a touch (contact) of an object on the first surface 111.

One end of the connection member 140 is connected to a second surface 112 of the first sensor unit 110, and an opposite end of the connection member 140 is connected to one end of the resilient body 130. That is, the connection member 140 connects the first sensor unit 110 and the resilient member 130.

The support 135 and the second sensor unit 120 are arranged at an opposite end of the resilient member 130. The second sensor unit 120 is installed to be spaced apart from the second surface 112 of the first sensor unit 110 by a specific spacing gap T. Here, the spacing gap T may be adjusted based on the specification of the device to which the touch input device 100 of the present disclosure is applied.

The resilient body 130 may be deformed upwards and downwards by a touch force that is applied to the first surface 111 of the first sensor unit 110 to deliver a touch force to the second sensor unit 120.

The support 135 supports the resilient body 130 and connects the resilient body 130 to the base plate 115.

Hereinafter, a shear force generation mechanism and a second touch location calculation method in the touch input 100 having the above-described structure will be described. Here, as illustrated in FIG. 2, it will be described as an example that two force sensors 120 are installed below the first sensor unit 110 at point A and point B.

As in FIG. 2, when an object such as a finger of the user or a stylus contacts (touches) one point on a first bottom surface 111 of the first sensor unit 110 while applying a force to the point, the first sensor control unit 210 calculates a point touched by the object as a first touch location P1 based on data measured by the first sensor unit 110 when the object contacts the first surface 111.

As in FIG. 2, when a force applied when a touch is input at the first touch location P1 is not applied in a direction that is perpendicular to the first bottom surface 111, a shear force S in a horizontal direction is generated. Accordingly, the second sensor control unit 220 calculates a second touch location P2 which is moved from the first touch location P1 by a specific distance D in a direction in which a shear force is applied, as a touch location. Here, the second sensor control unit 220 may calculate coordinates of the second touch location P2 by using a moment equation.

In this way, the touch location P1 measured by the first sensor unit 110 when a shear force S is generated and the touch location P2 measured by the second sensor unit 120 are different. In the present disclosure, an error between the touch location P1 measured by the first sensor unit 110 and the touch location P2 measured by the second sensor unit 120 is referred to as a distance D. That is, the distance D is a distance between the first touch location P1 and the second touch location P2, and is a difference between a distance D1 between point A (reference) and the first touch location P1, and a distance D2 between point A and the second touch location P2.

Meanwhile, a method of calculating the distance D2 between point A and the second touch location P2 will be described with reference to FIGS. 3 to 7.

FIG. 3 is a free body diagram illustrating a relationship between forces applied to the first sensor unit 110 and the second sensor unit 120 under the assumption that only a vertical load Fy is applied to the first touch location P1.

As illustrated in FIG. 3, a vertical repulsive force Ry1 may be applied to point A at which the second sensor unit 120 on one side is fixed, by the vertical load Fy applied to the first touch location P1, and a vertical repulsive force Ry2 may be applied to point B at which the second sensor unit 120 on an opposite side is fixed by the vertical load Fy. The vertical repulsive forces Ry1 and Ry2 may be assumed to have positive values in the Y axis of the coordinate system.

If an equilibrium equation of horizontally applied forces in FIG. 3 is applied, a relationship of ΣFY=Ry1+Ry2−Fy=0 is established, and Equation 1 may be calculated from the relationship.

$$Ry 1 = ( 1 - \frac{{D}_{1}}{L} ) Fy \qquad [ Equation 1 ]$$

Further, an equilibrium equation of a moment of point A in FIG. 3 is applied, a relationship of ΣMA=−D1Fy+LRy2=0 is established, and Equation 2 may be calculated from the relationship.

$$Ry 2 = \frac{{D}_{1}}{L} Fy \qquad [ Equation 2 ]$$

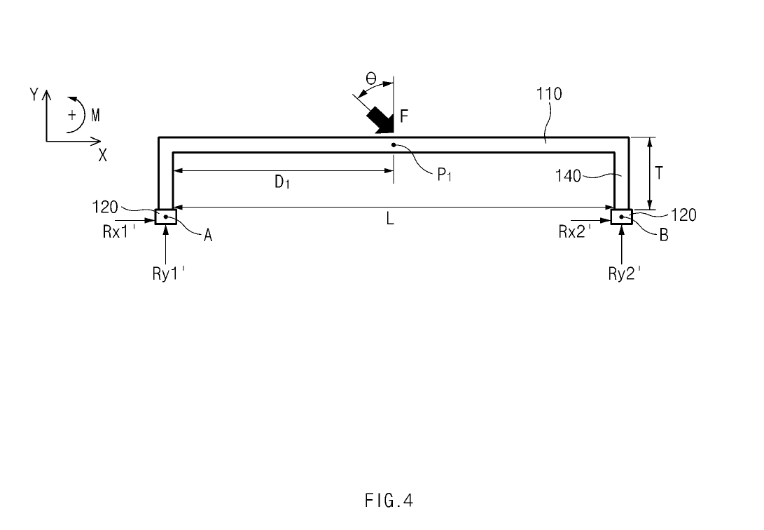

FIGS. 4 to 7 is a free body diagram illustrating an equilibrium relationship of forces applied to the first sensor unit 110 and the second sensor unit 120 when a shear force starts to be generated.

FIG. 4 is a free body diagram illustrating a state in which a force F that is large enough to generate a shear force is applied while being inclined at a specific angle θ with respect to a vertical line.

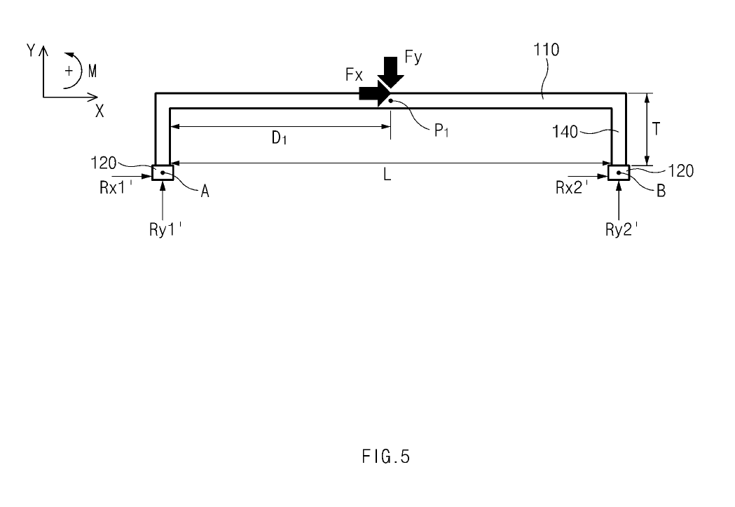

FIG. 5 illustrates a state in which the force F of FIG. 4 is decomposed into a vertical load Fy and a horizontal load Fx, and is an equivalent free body diagram of FIG. 4.

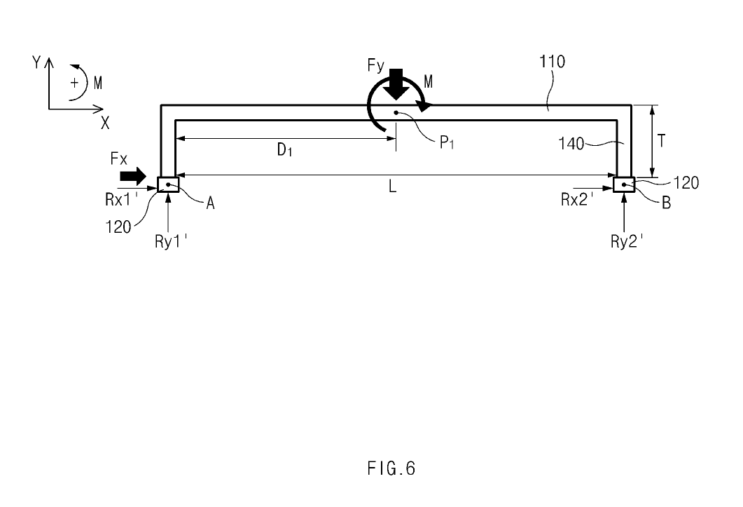

FIG. 6 illustrates that the horizontal load Fx of FIG. 5 is converted to an equivalent moment M at point D1, and is an equivalent free body diagram of FIG. 5.

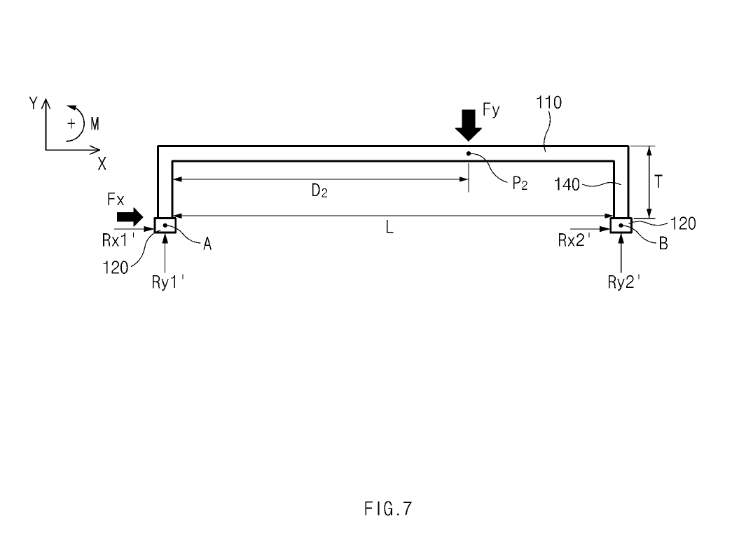

FIG. 7 illustrates that a point of action of the vertical load Fy is moved to point D2 by the moment M of FIG. 6, and is an equivalent free body diagram of FIG. 6.

As illustrated in FIGS. 4 to 7, a vertical repulsive force Ry1′ and a horizontal repulsive force Rx1′ may be applied to point A at which the second sensor unit 120 on one side is fixed, by the vertical load Fy and the horizontal load Fx applied to the first touch location P1, and a vertical repulsive force Ry2′ and a horizontal repulsive force Rx2′ may be applied to point B at which the second sensor unit 120 on an opposite side is fixed by the vertical load Fy. Here, it may be assumed that the vertical repulsive forces Ry1′ and Ry2′ have positive values in the Y axis of the coordinate system, and the horizontal repulsive forces Rx1′ and Rx2′ have positive values in the X axis of the coordinate system.

Further, an equilibrium equation of a moment of point A in FIG. 5 is applied, a relationship of ΣMA=−D1Fy−TFx+LRy2′=0 is established, and Equation 3 may be calculated from the relationship.

$$Ry {2}^{′} = \frac{{D}_{1}}{L} Fy + \frac{T}{L} Fx \qquad [ Equation 3 ]$$

If an equilibrium equation of horizontally applied forces in FIG. 5 is applied, a relationship of ΣFX=Rx1′+Rx2′+Fx=0 may be established.

If an equilibrium equation of horizontally applied forces in FIG. 5 is applied, a relationship of ΣFY=Ry1′+Ry2′−Fy=0 is established, and Equation 4 may be calculated by assigning Equation 3 in the relationship.

$$Ry {1}^{′} = ( 1 - \frac{{D}_{1}}{L} ) Fy - \frac{{D}_{1}}{L} Fx \qquad [ Equation 4 ]$$

Meanwhile, if Equation 1 is assigned in Equation 4, Equation 5 may be calculated.

$$Ry {1}^{′} = Ry 1 - \frac{T}{L} Fx \qquad [ Equation 5 ]$$

Further, if Equation 2 is assigned in Equation 3, Equation 6 may be calculated.

$$Ry {2}^{′} = Ry 2 + \frac{T}{L} Fx \qquad [ Equation 6 ]$$

It can be seen from Equation 5 and Equation 6 that as compared with a case in which only the vertical load Fy is applied, when the vertical load Fy and the horizontal load Fx are applied together, the vertical repulsive forces Ry1′ and Ry2′ increase or decrease due to an influence of the moment by the horizontal load Fx and the vertical spacing gap T.

Further, an equilibrium equation of a moment of point A in FIG. 7 is applied, a relationship of ΣMA=−D2Fy+LRy2′=0 may be established, and Equation 7 may be calculated by assigning Fy=Ry1′+Ry2′.

$${D}_{2} = \frac{LRy {2}^{′}}{Fy} = \frac{LRy {2}^{′}}{Ry {1}^{′} + Ry {2}^{′}} \qquad [ Equation 7 ]$$

Here, the vertical repulsive forces Ry1′ and Ry2′ may be measured by the second sensor unit 120, and D2 may be easily calculated as L is a known value.

Further, if Equation 2 is assigned in Equations 3 and 2, Equation 8 may be calculated.

$${D}_{2} = \frac{L \cdot Ry 2 + T \cdot Fx}{Fy} = {D}_{1} + T \cdot \frac{Fx}{Fy} = {D}_{1} + T \cdot tan θ \qquad [ Equation 8 ]$$

It can be seen from Equation 8 that the horizontal distance D2 of the second touch location P2 changed by the shear force is influenced by the first touch location P1 that corresponds to an initial touch applied by the first sensor unit 110, the vertical gap T between the first sensor unit 110 and the second sensor unit 120, and an inclination angle θ of a force applied during the touch.

If D2 is calculated through the equilibrium equation of the force and the vertical repulsive forces Ry1′ and Ry2′ measured by the second sensor unit 120, the difference between D2 and D1 may be calculated as ‘the distance (D=D2−D1) between the first touch location P1 and the second touch location P2’ by the shear force S.

Further, it can be seen from Equations 7 and 8, the vertical spacing gap T between the first sensor unit 110 and the second sensor unit 120 is a parameter of the above-described distance D.

Further, the shear force and the slide may be determined while a threshold function, which takes the distance D and various errors as parameters, is referenced. For example, the calculated distance D is larger than the value of the threshold function, a shear force is recognized, and when the calculated distance D is smaller than the value of the threshold function, a slide may be recognized.

In this way, according to the present disclosure, because a shear force may be easily generated when the first sensor unit 110 is touched and the spacing distance by the shear force may be accurately calculated by using the force measured by the second sensor unit 120 as well as the first sensor unit 110 and the second sensor unit 120 are vertically spaced apart from each other, the shear force may be recognized easily and precisely.

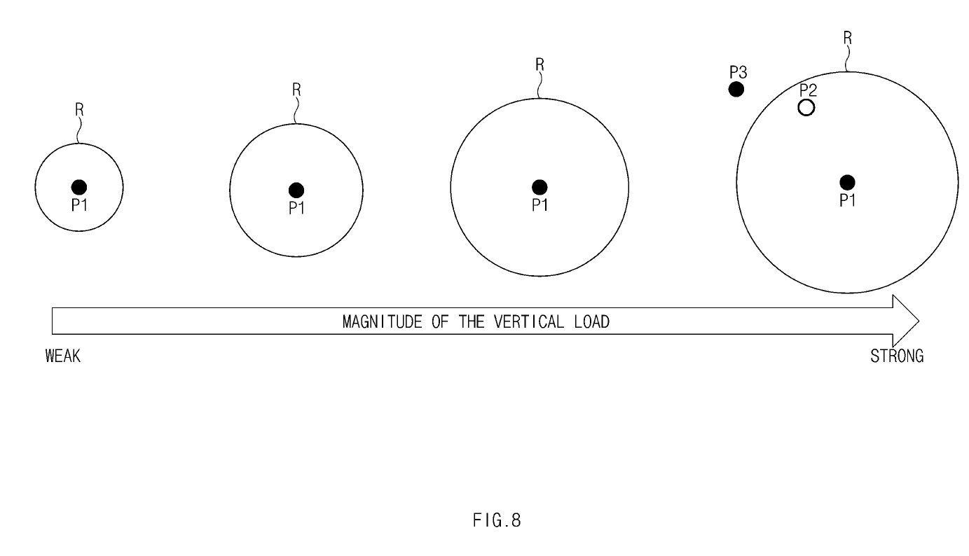

FIG. 8 is a view for explaining setting of a threshold value related to the present disclosure.

As illustrated in FIG. 8, the processing unit 240 may change and set a threshold value R based on a magnitude of a vertical load. Here, the threshold value R acts as a reference for determining the intention of the touch input of the user.

If P2 is measured as a second touch location by the second sensor unit 120, the processing unit 240 verifies whether the threshold value R is exceeded, by calculating a distance between the first touch location (reference location) P1 and the second touch location P2. If the calculated distance between the first touch location P1 and the second touch location P2 is less than the threshold value R, the processing unit 240 recognizes that a sliding event is generated.

Meanwhile, if P3 is measured as the second touch location by the second sensor unit 120, the processing unit 240 calculates a distance between the first touch location (reference location) P1 and the second touch location P3. If the calculated distance between the first touch location P1 and the second touch location P3 exceeds the threshold value R, the processing unit 240 recognizes that a shear force event is generated.

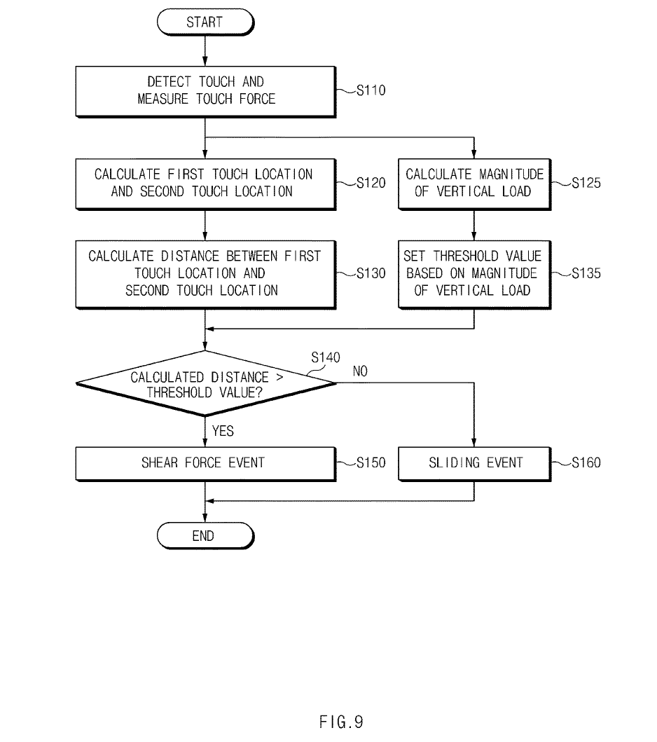

FIG. 9 is a flowchart illustrating a 3-D touch recognition method according to an embodiment of the present disclosure.

First, the control device 200 senses a touch and a touch force through the first sensor unit 110 and the second sensor unit 120 (S110). If a touch input is made to the touch surface 111, the first sensor unit 110 outputs a signal corresponding to the touch input. Further, the second sensor unit 120 measures force data applied by a touch force at a plurality of measurement points.

The control device 200 calculates a first touch location measured by the first sensor unit 110 and a second touch location measured by the second sensor unit 120 (S120). Here, if a touch input to a touch surface of the first sensor unit 110 is detected, the first sensor control unit 210 calculates a center coordinate of a contact area, which a finger contacts, as the first touch location. If a plurality of force data are input from the second sensor unit 120, the second sensor control unit 220 calculates the second touch location by using a force based touch location recognition algorithm.

The control device 200 calculates a distance between the first touch location and the second touch location (S130). That is, the control device 200 calculates a distance between the touch location measured by the first sensor unit 110 and the second touch location measured by the second sensor unit 120.

The control device 200 calculates the first touch location and the second touch location to calculate the magnitude of a vertical load by using a plurality of force data measured by the second sensor unit 120 (S125). Then, the magnitude of the vertical load is a total sum of the plurality of force data output from the second sensor unit 120.

Subsequently, the control device 200 sets a threshold value in consideration of the calculated magnitude of the vertical load, the sensor errors, and the like (S135). Here, the threshold value acts as a reference for determining the intention of the touch input of the user.

The control device 200 verifies whether a distance between the first touch location and the second touch location exceeds a threshold value. (S140).

If the calculated distance between the first touch location and the second touch location exceeds the threshold value, the control unit 200 recognizes that a shear force event is generated (S150). That is, the control device 200 recognizes that a shear force touch has been input by the user.

Meanwhile, if the calculated distance between the first touch location and the second touch location is the threshold value or less, the control unit 200 recognizes that a sliding event has been generated (S160). For example, the control device 200 recognizes that a touch input, such as flicking, is generated.

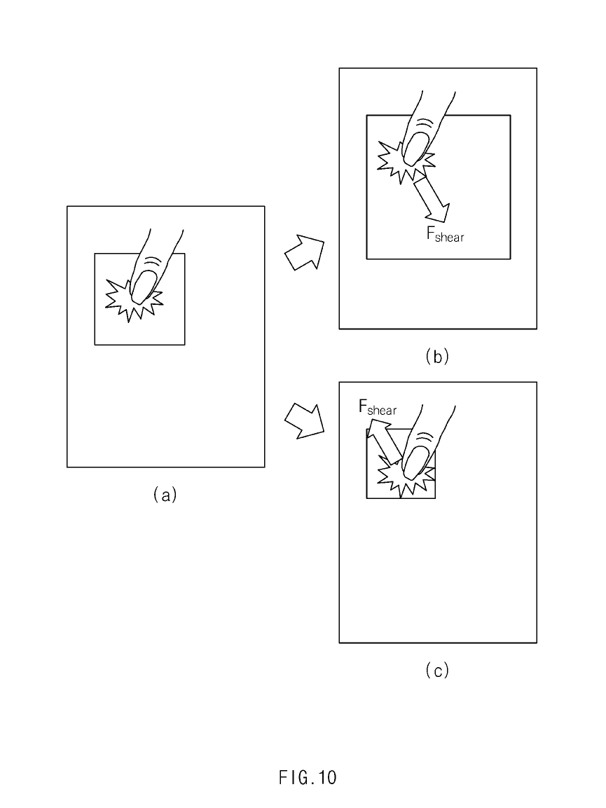

FIG. 10 is a view illustrating an example of performing enlargement and reduction through a shear force event according to the present disclosure.

As illustrated in FIG. 10, if the user applies a specific force to the right lower side in state a in which he or she touches a specific object displayed on the display screen, the control device 200 recognizes a shear force and enlarges the touched object to the right lower side (state b). The control device 200 increases the size of the object touched in the corresponding direction at a specific ratio while the touch force is applied.

Meanwhile, if a shear force touch to the left upper side is detected, the control device 200 reduces the size of the touch object in a direction in which the shear force is applied (state c).

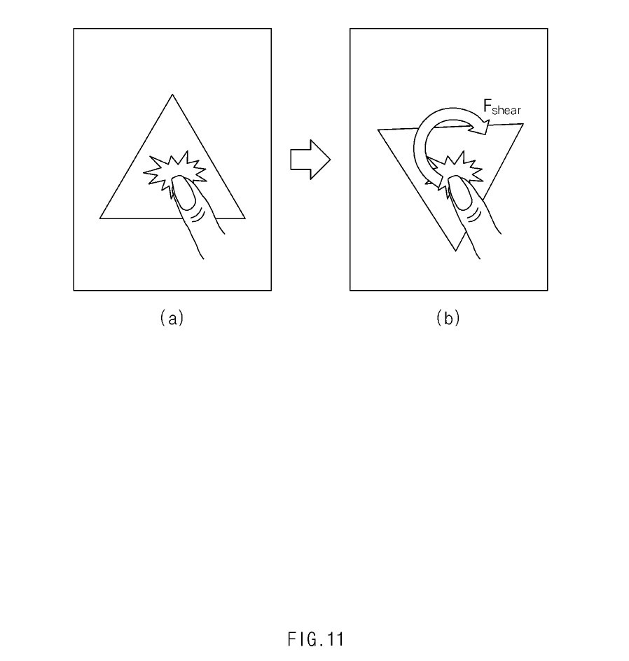

FIG. 11 illustrates an example of performing a rotation through a shear force touch according to the present disclosure.

As illustrated in FIG. 11, if the user applies a force to perform a clockwise rotation in state a in which he or she touches a screen with a finger, the control device 200 calculates a direction of the force that applies a shear force. The control device 200 rotates the object touched by the finger of the user based on the direction of the force, by which a shear force is applied (state b).

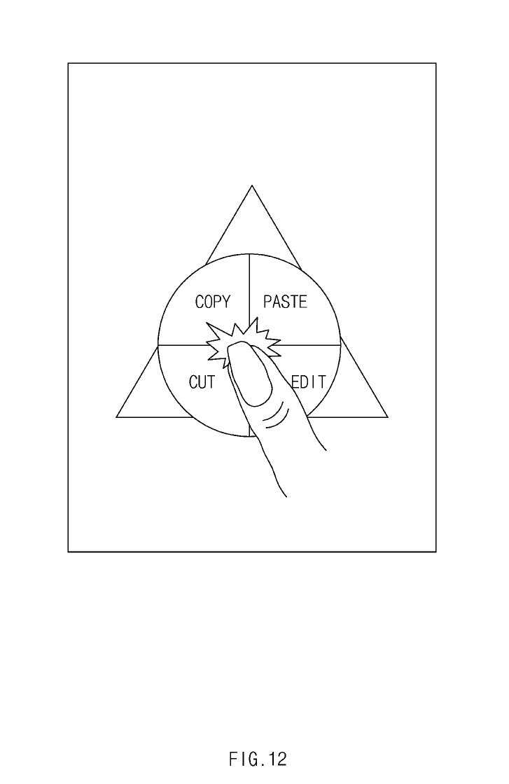

FIG. 12 illustrates an example of selecting a menu through a shear force touch according to the present disclosure.

As in FIG. 12, if the user applies a shear force in one direction in a state in which he or she touches the object displayed on the display unit 310, the control device 200 display a menu based on the touch location.

If a shear force is changed to a direction, in which any one item of the displayed menu is located, the control device 200 selects the corresponding item.

Although it has been described until now that all the elements that constitute the embodiments of the present disclosure are coupled into one or are coupled to each other to be operated, the present disclosure is not necessarily limited to the embodiments. That is, without departing from the purpose of the present disclosure, all the elements may be selectively coupled into one or more elements to be operated.

Further, although each of all the elements may be implemented by one piece of hardware independently, some or all of the elements may be selectively combined and may be implemented by a computer program having program modules for performing the functions of some or all elements combined by one or a plurality pieces of hardware. Codes and code segments that constitute the computer program may be easily inferred by those skilled in the art. The computer program may be stored in a computer-readable medium and read and executed by a computer to implement the embodiments of the present disclosure.

According to the present disclosure, a shear force event may be accurately recognized by using a spacing structure between a touch sensor and a force sensor.

Further, according to the present disclosure, as a reference for classifying intentions for touch inputs of the user is adjusted based on the magnitude of a vertical load by a touch force, a recognition rate of a shear force event may be improved.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A three-dimensional touch recognition apparatus comprising:
a first sensor unit configured to detect a touch;
a second sensor unit vertically spaced apart from the first sensor unit and configured to measure a touch force applied from the outside when the touch is detected at a plurality of measurement sites; and
a control device configured to calculate a distance between a first touch location measured by the first sensor unit and a second touch location measured by the second sensor unit and to verify whether the calculated distance between the first touch location and the second touch location exceeds a threshold value to recognize a touch input.

2. The apparatus of claim 1, wherein the first sensor unit comprises a touch pad, a touch film, or a touch sheet.

3. The apparatus of claim 1, wherein the first sensor unit uses a touch recognition technology selected from the group consisting of a resistive overlay type, a capacitive overlay type, a surface acoustic wave type, and an infrared beam type.

4. The apparatus of claim 1, wherein the second sensor unit comprises a plurality of force sensors arranged at different sites on one side of the first sensor unit.

5. The apparatus of claim 1, wherein the control device comprises:
a first sensor control unit configured to calculate the first touch location based on a signal output from the first sensor unit;
a second sensor control unit configured to calculate the second touch location by using a force based touch location recognition algorithm when a plurality of force data are input from the second sensor unit; and
a processing unit configured to calculate a distance between the first touch location and the second touch location, to verify whether the calculated distance exceeds the threshold value, and to classify the touch input based on a result of the verifying.

6. The apparatus of claim 5, wherein the processing unit is configured to calculate a magnitude of a vertical load at the second touch location by using the plurality of force data, and to set the threshold value based on the calculated magnitude of the vertical load.

7. The apparatus of claim 6, wherein the processing unit is configured to determine a sensor error when the threshold value is set.

8. The apparatus of claim 1, wherein the touch input is classified into a shear force event and a sliding event.

9. A three-dimensional touch recognition apparatus comprising:
a first sensor unit configured to detect a touch, wherein the first sensor unit comprises a touch pad, a touch film, or a touch sheet;
a second sensor unit vertically spaced apart from the first sensor unit and configured to measure a touch force applied from the outside when the touch is detected at a plurality of measurement sites, wherein the second sensor unit comprises a plurality of force sensors arranged at different sites on one side of the first sensor unit;
a first sensor control unit configured to calculate a first touch location based on a signal output from the first sensor unit;
a second sensor control unit configured to calculate a second touch location by using a force based touch location recognition algorithm when a plurality of force data are input from the second sensor unit; and
a processing unit configured to calculate a distance between the first touch location and the second touch location, to verify whether the calculated distance exceeds a threshold value, and to classify a touch input based on a result of the verifying.

10. The apparatus of claim 9, wherein the first sensor unit uses a touch recognition technology selected from the group consisting of a resistive overlay type, a capacitive overlay type, a surface acoustic wave type, and an infrared beam type.

11. The apparatus of claim 9, wherein the processing unit is configured to calculate a magnitude of a vertical load at the second touch location by using the plurality of force data, and to set the threshold value based on the calculated magnitude of the vertical load.

12. The apparatus of claim 11, wherein the processing unit is configured to determine a sensor error when the threshold value is set.

13. A three-dimensional touch recognition method comprising:
detecting a touch and a touch force through a first sensor unit and a second sensor unit that are vertically spaced apart from each other;
calculating a first touch location measured by the first sensor unit and a second touch location measured by the second sensor unit;
calculating a distance between the first touch location and the second touch location;
determining whether the distance between the first touch location and the second touch location exceeds a threshold value; and
recognizing a touch input based on whether the distance between the first touch location and the second touch location exceeds the threshold value.

14. The method of claim 13, wherein the first sensor unit comprises a sensor that uses a touch recognition technology selected from the group consisting of a resistive overlay type, a capacitive overlay type, a surface acoustic wave type, and an infrared beam type.

15. The method of claim 13, wherein the second sensor unit comprises a plurality of force sensors arranged at different sites on one side of the first sensor unit.

16. The method of claim 13, wherein the first touch location is calculated based on a signal output from the first sensor unit.

17. The method of claim 13, wherein the second touch location is calculated by applying a force based touch location recognition algorithm when a plurality of force data measured at a plurality of measurement sites by the second sensor unit are input.

18. The method of claim 13, further comprising:
after detecting the touch and the touch force, calculating a magnitude of a vertical load by using a plurality of force data that are output from the second sensor unit; and
setting the threshold value based on the magnitude of the vertical load.

19. The method of claim 13, wherein recognizing the touch input comprises recognizing that a shear force event is generated when a distance between the first touch location and the second touch location exceeds the threshold value.

20. The method of claim 13, wherein the recognizing of the touch input comprises recognizing that a sliding event is generated when a distance between the first touch location and the second touch location is the threshold value or less.
